(19) United States
(12) Patent Application Publication
(10) Pub. No.: US 2017/0169697 A1
(43) Pub. Date: Jun. 15, 2017

(54) Security Card Retrieval Notification System

(71) Applicant: John Patrick Madden, Sparks, MD (US)

(72) Inventor: John Patrick Madden, Sparks, MD (US)

(21) Appl. No.: 15/356,995

(22) Filed: Nov. 21, 2016

Related U.S. Application Data
(60) Provisional application No. 62/266,894, filed on Dec. 14, 2015.

(51) Int. Cl. G08B 21/24

(52) U.S. Cl. CPC G08B 21/24

(57) ABSTRACT

This invention was designed to prevent users from leaving security cards (used to authenticate into computer systems) into an IT system thereby presenting possible physical or informational security violations. The system consists of both a base transmitter unit and a receiver/holder unit for the security card. The system can present both audible and visual alerts to the user if the security id card is left in the computer system. Multiple receiver/holder units can sync off a single base transmitter unit.

### BACKGROUND OF INVENTION

The advent of the computer age brought a corresponding need for user authentication into computer systems to reduce unauthorized entry and data loss. Initially these efforts to secure the system(s) implemented passwords, but increasingly this method proved vulnerable to sophisticated attacks. To counter password attacks and data loss, IT systems now implement security cards with an embedded chip which may contain a system certification that identifies the user. This card is inserted into the computer, and the user is obligated to provide a user pin to gain entry into the system. While this solves some of the password hacker attack issues, it also presents a problem unto itself: what if the user walks away from the system and leaves the security card inside? Moreover, what if the security card had multiple uses, such as entrance/egress not only to the IT system, but to a physical entity such as a command center or other such building? Deserted authentication cards provide opportunity for nefarious users to compromise data systems (under the identity of the user), and introduce lost productivity for employers. The Security Card Retrieval Notification (SCRNS) System was designed to counter such issues by allowing the user to productively use IT assets whilst ensuring security/authentication cards are not inadvertently abandoned.

### BACKGROUND

To address deficiencies of the prior art, SCRNS encompasses two constituent units which maintain a telemetry link. The telemetry link ensures that the receiver is within a “protected zone” for security card usage. Whilst in this zone, the security card/id badge state with reference to the receiver/holder is irrelevant. Only when the receiver/holder loses sync from the transmitter (by leaving the zone) does the state of the security card/id badge with reference to the receiver/holder become crucial. If the receiver/holder does not detect the presence of the security card/id badge whilst the receiver has lost sync from the transmitter, an alarm to alert the user will be triggered. This prevents said user from unknowingly leaving the security card/id badge (or information system) in an unsecured state.

### FEDERAL FUNDINGS

N/A

### BRIEF DESCRIPTION OF DRAWINGS

FIG. 1: Basics of the system: a transmitter that syncs with a receiver using 1 of 125 possible channels. The receiver contains card detection circuitry to determine if the security card is in the card holder. There may be more than one receiver/holder units synced to the transmitter.

FIG. 2: Block diagram of the receiver/holder which employs an electronic switch to detect if the card is in the holder. Typically such security cards are used as an authentication mechanism to the computer system by containing a certificate of user credentials which the computer system can check. The security card can slide in/out of the holder.

### DESCRIPTION

The Security Card Retrieval Notification (SCRNS) System is a radio based telemetry system that ensures security or ID cards used for security purposes (entrance/egress, information system authentication, etc.) are not abandoned. The essential idea involves a low power telemetry link to a receiver attached to the security card holder worn by the user. Whilst the receiver (worn by the user) is within the range of the transmitter, the card may be used for technical duties without alarm. In the event that the receiver loses the link to the transmitter, an alarm is only sounded if the id card is not detected in the holder.

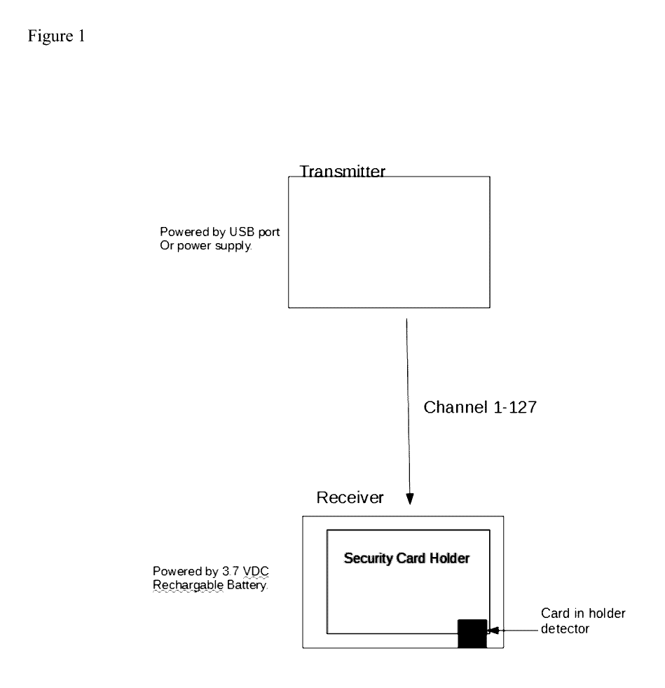

The system itself consists of two distinct components (see FIG. 1)—a transmitter (base unit) and a receiver (the card holder unit). The transmitter itself is a small, low-power 2.4 GHz wireless chip that can transmit on 128 channels, each of approximately 1 MHz. The range of the transmitter is between 50 -200 feet max with the built in antenna, although the addition of an external antenna will extend this range. The receiver itself must be tuned to the same channel as the transmitter for synchronization purposes (see FIG. 1). Windows software is provided to set both units to the same channel via the USB port. The receiver unit is worn or carried by the user and provides a place for the security card to reside in when not in use. The transmitter unit can be powered by a computer USB connection or a provided 3.3 volt power supply. The receiver unit is powered by a rechargeable 3.7 volt battery so that the unit can be carried about by the user of the system.

Initially, each unit (transmitter and receiver) is configured to channel 127. However, as there could potentially be interference from other base transmitters within range, this channel should be set to a channel not being used within the 50-200 foot range. The receiver unit provides a link light that provides an indication (set by software) the unit is receiving sync pulses from a transmitter. If this light is active and the transmitter is not activated, this indicates another nearby transmitter and a different channel should be employed. While the default range is 50-200 feet, several factors can influence this. The radio cannot permeate a block wall, so the system is limited in range by the physical, non-permeable surroundings.

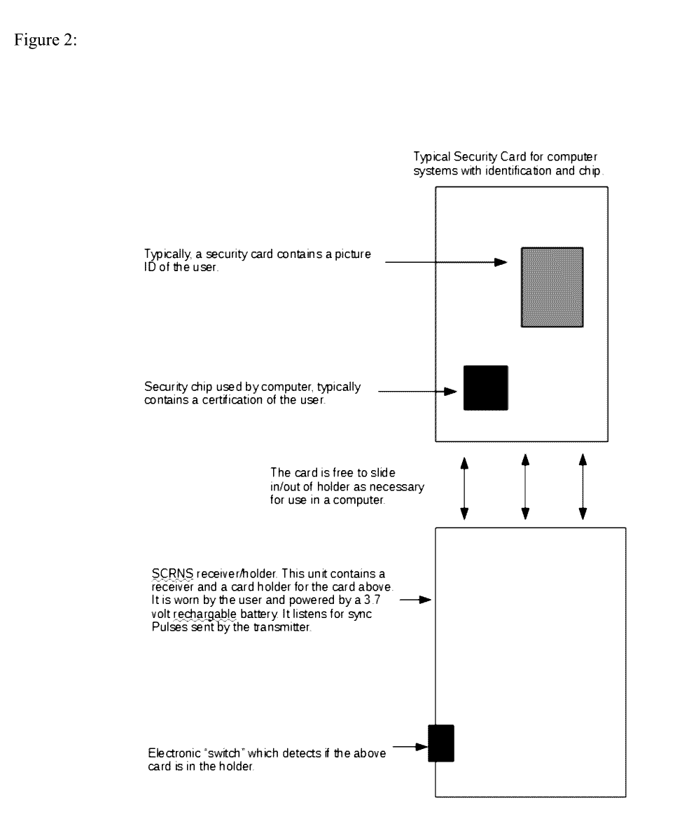

The receiver unit, worn or carried by the user, has a security card holder which itself employs break beam detection to determine if the card is in the holder or not (see FIG. 2). Whilst receiving sync pulses from the transmitter, the state of the card in the receiver/holder(present or not) is not relevant. This allows use of the card to perform duties required of the user. The user can freely move about within the reception range of the transmitter/receiver without issue.

Only when the receiver moves beyond the range of the transmitter does the state of the card with reference to the holder become salient. If the card is detected in the holder, no alarm is set despite the loss of sync pulse. However, if the card is not detected in the holder and the receiver loses the sync pulse an alarm signal is set alerting the user to the situation. This alarm signal can be temporarily arrested for about 20 seconds at a time (by a momentary push-button switch) until the user:

a) moves back within range of the transmitter or

b) places the card back in the holder.

Once the receiver detects that the card is back in the holder or receives the sync pulse from the transmitter, the alarm condition stops.

Both the transmitter and receiver/holder units contain microprocessors which maintain running logic and store configuration data in EEPROM. This data consists of the channel to transmit on, the contact frequency of each unit for synchronization, and (in the case of the receiver/holder unit) the type of alarm to set. Both units employ the NRF24L01 radio chip for telemetry purposes whilst the receiver also employs break beam technology to determine if the security card is present.

Configuring the system is made easy by use of Windows software that identifies the type (transmitter or receiver) of SCRNS unit and provides the ability to change the channel (1 of 127) used, transmit power settings, type of alert to receive (if the receiver unit), and the contact frequency. The contact frequency is how often the system

A. Sends out a sync pulse (if the unit is a transmitter).

B. Sets as a maximum number of seconds between sync pulses (if the unit is a receiver) before the receiver is considered out of sync.

A Windows application is provided to configure the SCRNS system components. There are no drivers required to be loaded for a Windows system

The system allows for multiple receiver/holder units to sync off the same base transmitter unit; this creates one area where several users are protected without having to set up multiple base transmitters. In this case, each receiver/holder unit would be set to the same channel. The size of the protected, or watched area, is directly proportional to the power setting of the transmitter unit and any physical limitations to RF energy.

1. A system for detecting the insertion state of a security authentication card to a holder/receiver that is user wearable. Whereas the base transmitter maintains a sync pulse over a telemetry link to said receiver to establish a protected area for the authentication or id card to be out of the holder. Said receiver detects if the security card is in the receive/holder, and sets an audible or visual alarm if the sync pulse is out of range/lost while security card is not present. Multiple receiver/transmitter units can sync off the same base unit operating on the same telemetry channel.

2. The system as in claim 1 wherein: the telemetry link consists of multiple, software selectable channels to reduce chances of interference from adjacent units.

3. The system as in claim 1 wherein: Windows software using usb connection of a computer to both transmitter and/or receivers for configuration purposes.

4. The system as in claim 1 wherein: The portable base transmitter emits a system of telemetry pulses to establish a protected area for receivers for purposes of computer id/authentication card usage.

5. The system as in claim 1 wherein: A combination security card holder and telemetry receiver unit that is user wearable; this combination unit detects if the security or id card is in the holder. If said receiver loses the sync pulse from said base transmitter and the card is not in the holder, a user configurable alarm triggers. Alarm can be audible, visual, or a combination of both. Said receiver/holder is powered by a rechargable battery housed in the unit itself.

6. The system as in claim 1 wherein: a reset momentary switch on the receiver/holder units will temporarily silence alarms condition (if they exists) for 20 seconds or until the alarm condition clears.

7. The system as in claim 1 wherein: A sync light (LED) on the receiver unit is activated if in sync with the transmitter and is turned off if sync is lost or unavailable.

8. The system as in claim 1 wherein: The transmitter can vary the power on the telemetry link to adjust the range and size of the protected area.
